(19) United States
(12) Patent Application Publication
(10) Pub. No.: US 2025/0190272 A1
(43) Pub. Date: Jun. 12, 2025

(54) TOKEN SYSTEM WITH PER-CORE TOKEN POOLS AND A SHARED TOKEN POOL

(71) Applicant: Dell Products L.P., Round Rock, TX (US)

(72) Inventors: Maher Kachmar, Dearborn Heights, MI (US); Vamsi K. Vankamamidi, Hopkinton, MA (US); Vladimir Shveidel, Pardes Hana-Karkur (IL)

(21) Appl. No.: 18/536,811

(22) Filed: Dec. 12, 2023

(51) Int. Cl. G06F 9/50

(52) U.S. Cl. CPC G06F 9/5066

(57) ABSTRACT

Per-core token pools and a shared token pool are provided, where each one of the per-core token pools corresponds to one of multiple processor cores. When the per-core token pool corresponding to the processor core used to process a received host I/O request contains at least the number of tokens required by the host I/O request, the tokens required by the host I/O request are allocated from that per-core token pool and the host I/O request is processed without accessing the shared token pool. The allocated tokens are returned to the per-core token pool until the tokens contained in the per-core target pool reaches a target quota for the per-core token pool. The remaining allocated tokens are returned to the shared token pool. Token imbalances may be addressed by periodically adjusting target quotas, and/or by allowing tokens to be dynamically allocated from another per-core token pool.

### TECHNICAL FIELD

The present disclosure relates generally to multi-core data storage systems that control resource utilization using token allocation.

### BACKGROUND

Data storage systems are arrangements of hardware and software that are coupled to non-volatile data storage drives, such as solid state drives and/or magnetic disk drives. The data storage system services host I/O requests received from physical and/or virtual host machines (“hosts”). The host I/O requests received by the data storage system specify host data that is written and/or read by the hosts. The data storage system executes software that processes the host I/O requests by performing various data processing tasks to efficiently organize and persistently store the host data in the non-volatile data storage drives of the data storage system.

A token pool may be used in a data storage system to control the consumption of resources within and/or used by the data storage system. Performing an operation may require allocation of one or more tokens from the pool. When the operation is completed, the allocated tokens are returned to the token pool for reallocation.

### SUMMARY

In the disclosed technology, a shared token pool and multiple per-core token pools are initialized. Each one of the per-core token pools individually corresponds to a respective one of multiple processor cores. A host I/O (Input/Output) request is received, and a processor core to be used for processing the host I/O request is identified among the multiple processor cores. The number of tokens that are required by the host I/O request is calculated. In response to the per-core token pool that corresponds to the identified processor core containing a total number of tokens that is equal to at least the number of tokens required by the host I/O request, i) the number of tokens required by the host I/O request is allocated from the per-core token pool corresponding to the identified processor core, and ii) the host I/O request is processed, without accessing the shared token pool.

In some embodiments, in response to the per-core token pool corresponding to the identified processor core not containing a total number of tokens equal to at least the number of tokens required by the host I/O request, some tokens are allocated from the shared token pool, and the host I/O request is processed.

In some embodiments, allocating tokens from the shared token pool includes allocating tokens from the shared token pool in bulk, such that a total number of tokens that are allocated is larger than the number of tokens required by the host I/O request.

In some embodiments, in response to completion of the host I/O request, the allocated tokens are returned by returning allocated tokens to the per-core token pool until a total number of tokens contained in the per-core target pool reaches a target quota for the per-core token pool. After the total number of tokens contained in the per-core token pool reaches the target quota for the per-core token pool, any remaining allocated tokens are returned to the shared token pool.

In some embodiments, each one of the multiple per-core token pools has a separate target quota, and initializing the shared token pool and per-core token pools includes setting the target quota of each one of the per-core token pools to an initial value.

In some embodiments, rebalancing of the per-core token pools is performed periodically by detecting whether a workload change has occurred for any of the processor cores. In response to detecting a workload change for one of the processor cores, the value of the target quota of the per-core token pool corresponding to that processor core is changed to reflect the workload change.

In some embodiments, to address imbalances between the per-core token pools, in response to detecting that the per-core token pool corresponding to the identified processor core and the shared pool together do not contain a total number of tokens equal to at least the number of tokens required to process the host I/O request, some tokens may be allocated from another one of the per-core token pools to reach the number of tokens required to process the host I/O request, and the host I/O request is then processed.

The disclosed technology is integral to providing a practical technical solution to the problem of high cache line contention levels or cache trashing that may occur in systems without the disclosed technology, when allocating and returning tokens needed to process large numbers of received host I/O requests. In general, processing of each host I/O request may require allocating some number of tokens from at least one token pool, and then returning the allocated tokens when the processing is completed. At least one token pool state variable is maintained for each token pool, i.e. to track the number of tokens currently available for allocation in that token pool. Without the disclosed technology, in a data storage system in which host I/O requests are processed independently across multiple processor cores, and in which all token pools are shared across all the processor cores, both token allocation and release operations always require performing atomic operations, in order to avoid data corruption when adjusting the number of currently available tokens in each token pool that is accessed. Accordingly, under high host I/O request loads, large numbers of atomic operations are required to be performed to adjust the currently available tokens in each accessed token pool. This may lead to high levels of cache line contention or cache thrashing, since the relevant cache line must be newly fetched each time a currently available tokens state variable is changed. As a result, in systems without the disclosed technology, resource utilization, e.g. in terms of processor cycles consumed per byte of data processed by host I/O requests (also known as “cycles per byte”, or “CPB”), is negatively impacted. Moreover, in systems without the disclosed technology in which processing of each host I/O request requires that tokens be allocated from multiple shared token pools, e.g. both a system-wide shared token pool and one of multiple shared Quality of Service (QoS) token pools, the impact on CPB is even greater.

Advantageously, in systems using the disclosed technology, in cases where the number of tokens required by a host I/O request can be completely allocated from a per-core token pool corresponding to the processor core identified for processing the host I/O request, using only the per-core token pool eliminates the need to access the shared token pool. Adjustments performed on the token pool state variable indicating the currently available tokens of the per-core token pools, i.e. when allocating and releasing tokens of the per-core token pools, do not require atomic operations, since the token pool state variable indicating the number of tokens contained in the per-core token pools is not shared across processor cores. Processing received host I/O requests using tokens allocated from per-core token pools accordingly reduces overall cache line contention, and avoids cache thrashing, thus improving overall system performance by reducing CPB while processing large numbers of received host I/O requests. Moreover, in systems in which both system wide and QoS specific tokens must be allocated to process each host I/O request, the disclosed technology may be embodied to provide both i) per-core token pools and a shared token pool for allocating system wide tokens, and ii) per-core token pools and a shared token pool for each specific QoS level from which QoS specific tokens can be allocated.

The foregoing summary does not indicate required elements, or otherwise limit the embodiments of the disclosed technology described herein. The technical features described herein can be combined in any specific manner, and all combinations may be used to embody the disclosed technology.

### BRIEF DESCRIPTION OF THE DRAWINGS

The objects, features and advantages of the disclosed technology will be apparent from the following description of embodiments, as illustrated in the accompanying drawings in which like reference numbers refer to the same parts throughout the different views. The drawings are not necessarily to scale, emphasis instead being placed on illustrating the principles of the disclosed technology.

FIG. 1 is a block diagram showing an example of a data storage system including an illustrative embodiment of the disclosed technology;

FIG. 2 is a flow chart showing an illustrative example of steps performed during operation of some embodiments of the disclosed multilevel token pool technology;

FIG. 3 is a flow chart showing an illustrative example of steps performed by some embodiments of the disclosed technology to periodically rebalance token pools;

FIG. 4 is a flow chart showing an illustrative example of steps performed by some embodiments of the disclosed technology to dynamically address token pool imbalances; and

FIG. 5 is a flow chart showing an example of steps performed in some embodiments.

### DETAILED DESCRIPTION

Embodiments will now be described with reference to the figures. The embodiments described herein are not limiting, and are provided only as examples, in order to illustrate various features and principles of the disclosed technology. The embodiments of disclosed technology described herein are integrated into a practical solution to the problem of high levels of cache line contention or cache trashing that may occur when allocating and returning tokens to process high numbers of host I/O requests.

The disclosed technology initializes a shared token pool and multiple per-core token pools, where each one of the per-core token pools individually corresponds to a respective one of multiple processor cores in a data storage system. When a host I/O (Input/Output) request is received by the data storage system, a processor core is identified that is to be used for processing the host I/O request, and the number of tokens that are required by the host I/O request is calculated. In response to the per-core token pool corresponding to the identified processor core containing a total number of tokens equal to at least the number of tokens required by the host I/O request, the disclosed technology i) allocates the number of tokens required by the host I/O request from the per-core token pool corresponding to the identified processor core, and ii) processes the host I/O request, without accessing the shared token pool.

In response to the per-core token pool corresponding to the identified processor core not containing a total number of tokens equal to at least the number of tokens required by the host I/O request, some tokens may be allocated from the shared token pool, and the host I/O request is processed. Allocating tokens from the shared token pool may include allocating tokens from the shared token pool in bulk, such that the total number of tokens that are allocated is larger than the number of tokens required by the current host I/O request.

In response to completion of the host I/O request, tokens allocated for processing of the I/O request are returned by returning the allocated tokens to the per-core token pool until a total number of tokens contained in the per-core target pool reaches a target quota for the per-core token pool. After the total number of tokens contained in the per-core token pool reaches the target quota for the per-core token pool, any remaining allocated tokens are returned to the shared token pool.

Each one of the multiple per-core token pools may have its own separate target quota, and initializing the shared token pool and per-core token pools may include setting the target quota of each one of the per-core token pools to an initial value. Rebalancing of the per-core token pools may be performed periodically, by detecting whether a workload change has occurred for any of the processor cores. In response to detecting that the workload of one of the processor cores has changed, the value of the target quota of the per-core token pool corresponding to that processor core may be adjusted up or down to reflect the workload change.

In some embodiments, in response to detecting that the per-core token pool corresponding to the identified processor core and the shared pool together do not contain a total number of tokens equal to at least the number of tokens required to process the host I/O request, some tokens may be allocated from another one of the per-core token pools in order for the host I/O request to be processed.

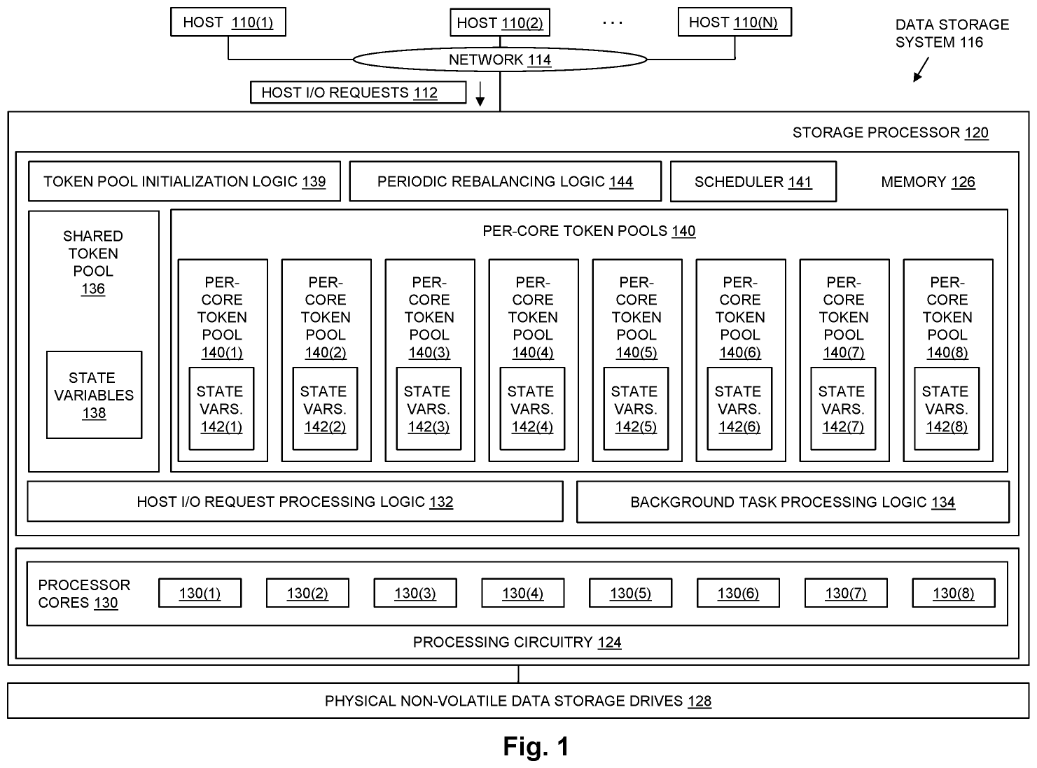

FIG. 1 is a block diagram showing an operational environment for the disclosed technology, including an example of a data storage system in which the disclosed technology is embodied. FIG. 1 shows a number of physical and/or virtual Host Computing Devices 110, referred to as “hosts”, and shown for purposes of illustration by Hosts 110(1) through 110(N). The hosts and/or applications executing thereon may access non-volatile data storage provided by Data Storage System 116, for example over one or more networks, such as a local area network (LAN), and/or a wide area network (WAN) such as the Internet, etc., and shown for purposes of illustration in FIG. 1 by Network 114. Alternatively, or in addition, one or more of Hosts 110 and/or applications accessing non-volatile data storage provided by Data Storage System 116 may execute within Data Storage System 116.

Data Storage System 116 includes at least one Storage Processor 120 that is communicably coupled to both Network 114 and Physical Non-Volatile Data Storage Drives 128, e.g. at least in part though one or more communication interfaces of Storage Processor 120. No particular hardware configuration is required, and Storage Processor 120 may be embodied as any specific type of device that is capable of processing host input/output (I/O) requests (e.g. I/O read requests and I/O write requests, etc.), and of persistently storing host data.

The Physical Non-Volatile Data Storage Drives 128 may include physical data storage drives such as solid state drives, magnetic disk drives, hybrid drives, optical drives, and/or other specific types of drives.

A Memory 126 in Storage Processor 120 stores program code that is executed on Processing Circuitry 124, as well as data generated and/or processed by such program code. Memory 126 may include volatile memory (e.g. RAM), and/or other types of memory.

Processing Circuitry 124 includes or consists of multiple Processor Cores 130, e.g. within one or more multi-core processor packages. In the example of FIG. 1, Processor Cores 130 includes processor cores 130(1), 130(2), 130(3), 130(4), 130(5), 130(6), 130(7), and 130(8). While the example of FIG. 1 shows eight processor cores, those skilled in the art will recognize that the disclosed technology may be embodied using any specific number of processor cores.

Each processor core in Processor Cores 130 includes or consists of a separate processing unit, sometimes referred to as a Central Processing Unit (CPU). Each individual processor core in Processor Cores 130 is made up of separate electronic circuitry that independently executes instructions, e.g. instructions within program logic scheduled for execution on that processor core by Scheduler 141.

Processing Circuitry 124 and Memory 126 together form control circuitry that is configured and arranged to carry out various methods and functions described herein. The Memory 126 stores a variety of software components that may be provided in the form of executable program code, including Token Pool Initialization Logic 139, Host I/O Request Processing Logic 132, Background Task Processing Logic 134, Periodic Rebalancing Logic 144, and Scheduler 141. When the program code stored in Memory 126 is executed by Processing Circuitry 124, Processing Circuitry 124 is caused to carry out the operations of the software components described herein. Although certain software components are shown in the Figures and described herein for purposes of illustration and explanation, those skilled in the art will recognize that Memory 126 may also include various other specific types of software components.

During operation of the illustrative embodiment shown in FIG. 1, Shared Token Pool 136 and Per-Core Token Pools 140 are initialized, e.g. by Token Pool Initialization Logic 139. Each one of the per-core token pools individually corresponds to a respective one of Processor Cores 130. For example, Per-Core Token Pool 140(1) corresponds to Processor Core 130(1), Per-Core Token Pool 140(2) corresponds to Processor Core 130(2), Per-Core Token Pool 140(3) corresponds to Processor Core 130(3), Per-Core Token Pool 140(4) corresponds to Processor Core 130(4), Per-Core Token Pool 140(5) corresponds to Processor Core 130(5), Per-Core Token Pool 140(6) corresponds to Processor Core 130(6), Per-Core Token Pool 140(7) corresponds to Processor Core 130(7), and Per-Core Token Pool 140(8) corresponds to Processor Core 130(8).

Initialization of Shared Token Pool 136 and Per-Core Token Pool 140 may include setting the number tokens contained in Shared Token Pool 136 to a first predetermined initial value, and setting the number of tokens contained in each one of the per-core token pools to a second predetermined initial value. For example, in some embodiments, the initial number of tokens contained in each one of the per-core token pools may be set to a predetermined low watermark value. The low watermark value defines a minimum number of tokens that may be contained in any per-core token pool at any time. Alternatively, the number of tokens contained in each one of the per-core tokens pools may be initially set equal to zero.

For each token pool, the number of tokens currently contained in that token pool is the number of tokens that are currently available for allocation from that token pool, and may be stored in a CURRENTLY_CONTAINS variable for that token pool. For example, State Variables 138 for Shared Token Pool 136 may include a CURRENTLY_CONTAINS variable that stores the number of tokens currently contained in Shared Token Pool 136, State Variables 142(1) for Per-Core Token Pool 140(1) may include a CURRENTLY_CONTAINS variable that stores the number of tokens currently contained in Per-Core Token Pool 140(1), State Variables 142(2) for Per-Core Token Pool 140(2) may include a CURRENTLY_CONTAINS variable that stores the number of tokens currently contained in Per-Core Token Pool 140(2), State Variables 142(3) for Per-Core Token Pool 140(3) may include a CURRENTLY_CONTAINS variable that stores the number of tokens currently contained in Per-Core Token Pool 140(3), State Variables 142(4) for Per-Core Token Pool 140(4) may include a CURRENTLY_CONTAINS variable that stores the number of tokens currently contained in Per-Core Token Pool 140(4), State Variables 142(5) for Per-Core Token Pool 140(5) may include a CURRENTLY_CONTAINS variable that stores the number of tokens currently contained in Per-Core Token Pool 140(5), State Variables 142(6) for Per-Core Token Pool 140(6) may include a CURRENTLY_CONTAINS variable that stores the number of tokens currently contained in Per-Core Token Pool 140(6), State Variables 142(7) for Per-Core Token Pool 140(7) may include a CURRENTLY_CONTAINS variable that stores the number of tokens currently contained in Per-Core Token Pool 140(7), and State Variables 142(8) for Per-Core Token Pool 140(8) may include a CURRENTLY_CONTAINS variable that stores the number of tokens currently contained in Per-Core Token Pool 140(8).

When a host I/O (Input/Output) request (e.g. one of Host I/O Requests 112) is received by the Data Storage System 116 (e.g. by Storage Processor 120), Scheduler 141 identifies one of the processor cores within Processor Cores 130 to be used for processing of that host I/O request. For example, for each individual received host I/O request, Scheduler 141 may identify a processor core on which Host I/O Processing Logic 132 is to be executed in order for that host I/O request to be processed.

Host I/O Request Processing Logic 132 performs in-line processing of the host I/O requests received by Storage Processor 120. Such processing may, for example, include processing of block-based host I/O requests received by Storage Processor 120. The in-line processing may include all processing of each received host I/O write request that is necessary to be completed before an acknowledgement is returned to the host the host I/O request indicating that the host data indicated by the I/O write request has been securely stored by Data Storage System 116. In-line processing of host I/O write requests may include securely storing the host data indicated by the I/O write requests either into a cache and/or into Physical Non-Volatile Data Storage Drives 128. In the case of received host I/O read requests, the in-line processing may include reading requested host data from the cache or Physical Non-Volatile Data Storage Drives 128, and additional data processing that may be necessary, such as decompression, decryption, etc., of the requested host data, followed by transmitting the requested host data to the host that issued the host I/O request.

In some embodiments, a first group of processor cores in Processor Cores 130 (e.g. processor cores 130(1), 130(2), 130(3), and 130(4)) is used to exclusively (or primarily) execute Host I/O Request Processing Logic 132, and a second group of processor cores (e.g. processor cores 130(5), 130(6), 130(7), and 130(8)) is used to exclusively (or primarily) execute Background Task Processing Logic 134. The specific processor cores that are contained in the first group and the second group may be changed dynamically, e.g. in response to changes that may occur in the workload of Data Storage System 116, such as changes in the workload provided by Host I/O Requests 112.

Background Task Processing Logic 134 performs background processing of host data that is not performed in-line, and which may be deferred. Background processing of host data may include processing of host data indicated by I/O write requests that can be performed after an acknowledgement is returned to the host indicating that the host data indicated by the host I/O write request has been securely stored in the Data Storage System 116, and/or flushing of host data from a cache to Physical Non-Volatile Data Storage Drives 128. Other examples of background processing of host data may include compression, deduplication, and/or encryption of host data stored in either the cache and/or Physical Non-Volatile Data Storage Drives 128.

For example, Scheduler 141 may identify a processor core on which Host I/O Processing Logic 132 is to execute while processing a specific received host I/O request by identifying one of the processor cores in the group of processor cores that is being used to execute Host I/O Request Processing Logic 132. In some embodiments, one of the processor cores in the group of processor cores in the group of processor cores that is being used to execute Host I/O Request Processing Logic 132 may be selected that is currently less busy than the other processor cores in the group of processor cores that is being used to execute Host I/O Request Processing Logic 132.

After Scheduler 141 identifies a processor core to execute Host I/O Request Processing Logic 132 while Host I/O Request Processing Logic 132 processes the host I/O request, Host I/O Request Processing Logic 132 begins execution on the identified processor core in order to process the host I/O request. Host I/O Request Processing Logic 132 first calculates the number of tokens that are required by the host I/O request, i.e. the number of tokens that must be allocated in order for the host I/O request to be completely processed.

The number of tokens that are required by the host I/O request may be calculated based on the size of the host data associated with the host I/O request, and/or on the type of the host I/O request (e.g. write or read request). Relatively larger host I/O requests may require larger numbers of tokens to be processed. For example, a four kilobyte host I/O write request may require 200 tokens, an eight kilobyte host I/O write request may require 400 tokens, etc. Host I/O read requests may require smaller numbers of tokens to be processed than similarly sized host I/O read requests. For example, a four kilobyte host I/O read request may require 100 tokens to be processed, an eight kilobyte host I/O read request may require 200 tokens to be processed, etc.

After the number of tokens required by the host I/O request is calculated, the per-core token pool corresponding to the processor core identified for processing the host I/O request is checked (e.g. by Host I/O Request Processing Logic 132) to determine whether that per-core token pool currently contains a total number of tokens that are available for allocation equal to at least the number of tokens required by the host I/O request. For example, in the case where the processor core identified for execution of Host I/O Processing Logic 132 is processor core 130(1), and where the host I/O request requires 400 tokens, the value of the CURRENTLY_CONTAINS variable in State Variables 142(1) is compared to 400. If the value of the CURRENTLY_CONTAINS variable in State Variables 142(1) is equal to at least 400 (i.e. is 400 or greater), then Host I/O Request Processing Logic 132 continues executing on processor core 130(1) and i) allocates the required number of tokens (e.g. 400) completely from per-core token pool 140(1), e.g. by subtracting the required number of tokens (e.g. 400) from the CURRENTLY_CONTAINS variable in State Variables 142(1), and ii) processes the host I/O request, e.g. by performing the in-line processing of the host I/O request that is necessary to be completed before an acknowledgement is returned to the host that issued host I/O request, e.g. in the case of a host I/O write request an acknowledgment indicating that the host data indicated by the I/O write request has been securely stored by Data Storage System 116. In this example, where the required number of tokens were determined to be available in and then allocated from a per-core token pool, the shared token pool is not accessed. Specifically, the 400 tokens are allocated from per-core token pool 140(1) and the host I/O request was processed without accessing Shared Token Pool 136, avoiding costly atomic operations that may be needed to access Shared Token Pool 136. Advantageously, neither the comparing of the CURRENTLY_CONTAINS variable in State Variables 142(1) to the required number of tokens (e.g. 400) nor the subtracting of the required number of tokens (e.g. 400) from the CURRENTLY_CONTAINS variable in State Variables 142(1) requires performing an atomic operation.

In response to per-core token pool 140(1) not containing a total number of tokens equal to at least the number of tokens required by the host I/O request, e.g. where the CURRENTLY_CONTAINS variable in State Variables 142(1) is less than 400, some tokens may be allocated from Shared Token Pool 136 to make up the difference, and the host I/O request then allowed to be processed. For example, if the CURRENTLY_CONTAINS variable in State Variables 142(1) is equal to 200, then the Shared Token Pool 136 is checked to see whether it contains the additional 200 tokens necessary to be allocated in order for the host I/O request to be processed, e.g. whether the CURRENTLY_CONTAINS variable in State Variables 138 is equal to at least 200. If so, then the additional required 200 tokens are allocated from Shared Token Pool 136 (e.g. by subtracting 200 from CURRENTLY_CONTAINS in State Variables 138). The checking and decrementing of CURRENTLY_CONTAINS in State Variables 138 may require performing at least one atomic operation.

In some embodiments or configurations, allocation of the additional required tokens from Shared Token Pool 136 may include allocating tokens from Shared Token Pool 136 in bulk, such that the total number of tokens that are allocated is larger than the number of tokens required by the current host I/O request. Such bulk allocations of tokens may cause some tokens (e.g. tokens allocated above the number of tokens required by the host I/O request) to be moved from the Shared Token Pool 136 to the per-core token pool (e.g. to per-core token pool 140(1)). For example, in a case where an additional 200 tokens are required to be allocated from Shared Token Pool 136 in order for the host I/O request to be processed, a bulk allocation of 1000 tokens may instead be made from Shared Token Pool 136. The host I/O request is then processed. After processing of the host I/O request is complete, during the process of returning tokens that were allocated in order for the host I/O request to be processed, in addition to any tokens allocated from the per-core token pool, some or all of the tokens allocated from the Shared Token Pool 136 may be returned to the per-core token pool (e.g. to Per-Core Token Pool 140(1)), until the total number of tokens in the per-core token pool reaches a target quota the per-core token pool. In this way, the number of tokens in the relevant per-core token pool available for allocation may be increased with tokens from the shared token pool, in anticipation of needing more tokens in the per-core token pool to process future host I/O requests without having to access the shared token pool. In a configuration in which the per-core token pools are initialized with zero tokens, bulk allocations from Shared Token Pool 136 also enables the per-core token pools to be loaded with tokens from Shared Token Pool 136, up to their individual target quotas, in response to host I/O request processing being scheduled on their corresponding processor cores.

In general, in response to completion of the host I/O request, Host I/O Request Processing Logic 132 returns the tokens that were previously allocated for processing of the I/O request by first returning allocated tokens to the relevant per-core token pool until a total number of tokens contained in that per-core target pool reaches its target quota. Each per-core token pool may have its own independently configurable target quota, e.g. a TARGET_QUOTA variable within its state variables. For example, Per-Core Token Pool 140(1) may have a TARGET_QUOTA within State Variables 142(1). After processing of a host I/O request by executing Host I/O Request Processing Logic 132 on processor core 130(1), tokens that were allocated to process that host I/O request, whether allocated from Per-Core Token Pool 140(1) or Shared Token Pool 136, are first returned to Per-Core Token Pool 140(1) up to the target quota for Per-Core Token Pool 140(1), e.g. by incrementing the CURRENTLY_CONTAINS variable in State Variables 142(1) for each returned token until CURRENTLY_CONTAINS is equal to the value of the TARGET_QUOTA variable in State Variables 142(1). For example, if 400 tokens were allocated to process a host I/O request by execution of Host I/O Request Processing Logic 132 on processor core 130(1), 200 tokens from Per-Core Token Pool 140(1) and 200 tokens from Shared Token Pool 136, after processing of the host I/O request completes Host I/O Request Processing Logic 132 returns all the 400 allocated tokens. In the event that Per-Core Token Pool 140(1) contains 200 tokens at the time host I/O request processing completes (CURRENTLY_CONTAINS in State Variables 142(1) equals 200), and the target quota for Per-Core Token Pool 140(1) is 500 at that time (TARGET_QUOTA in State Variables 142(1) equals 500), then the first 300 of the previously allocated tokens are returned to Per-Core Token Pool 140(1), e.g. by incrementing CURRENTLY_CONTAINS in State Variables 142(1) up to 500. After the total number of tokens contained in Per-Core Token Pool 140(1) reaches the target quota for Per-Core Token Pool 140(1), the remaining 100 allocated tokens are returned to Shared Token Pool 136. In this example, the remaining 100 tokens that were allocated for the host I/O request are returned to Shared Token Pool 136, e.g. by increasing the value of CURRENTLY_CONTAINS in State Variables 138 by 100.

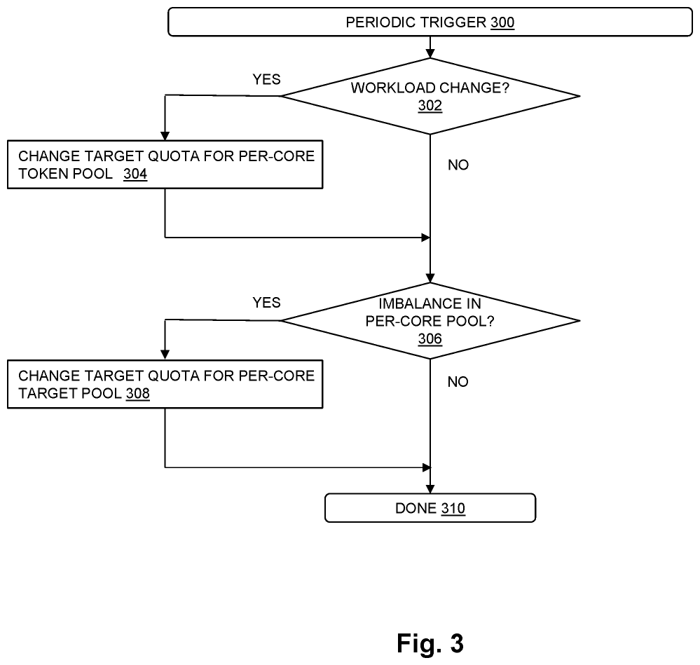

Each one of the per-core token pools in Per-Core Token Pools 140 has its own separate, independently settable target quota variable (“TARGET_QUOTA”) within its state variables. Initialization of the Per-Core Token Pools 140 by Token Pool Initialization Logic 139 may include initializing the target quota variable for each per-core token pool to a predetermined initial value. The value of the target quota variable for each per-core token pool may be dynamically modified during periodic token pool rebalancing. In some embodiments, rebalancing of the per-core token pools is performed periodically by Periodic Rebalancing Logic 144. Periodic Rebalancing Logic 144 may, for example, be triggered multiple times per second. Periodic Rebalancing Logic 144 may dynamically modify the target quota variable of one or more per-core token pools in response to detecting that a workload change has occurred with regard to the corresponding processor cores. The target quota is modified to reflect the detected workload change, e.g. the target quota may be increased in response to detecting an increased workload on the corresponding processor core, and the target quota may be decreased in response to detecting a decreased workload on the corresponding processor core. Periodic token pool rebalancing is further illustrated by and described with reference to FIG. 3.

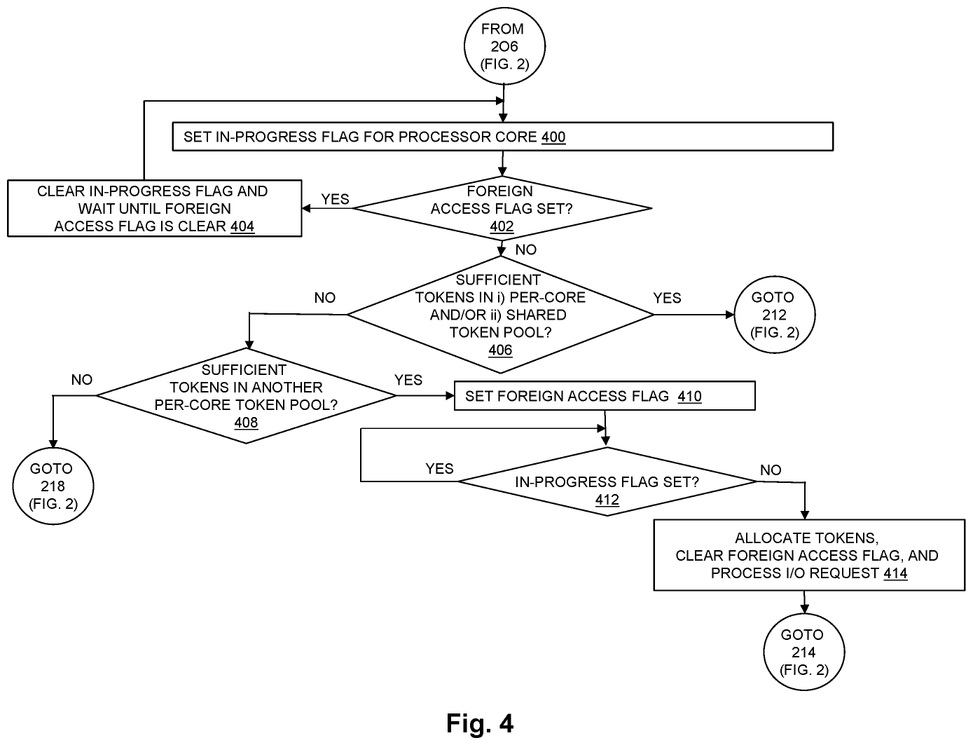

In some embodiments, to further address imbalances between the per-core token pools, and in response to Host I/O Request Processing Logic 132 detecting that a per-core token pool corresponding to a processor core identified for processing a received host I/O request and the shared pool together do not contain a total number of tokens equal to at least the number of tokens required to process the received host I/O request, some tokens may be allocated from another one of the per-core token pools in order to reach the number of tokens required to process the host I/O request, thereby enabling the host I/O request to be processed. This embodiment is further illustrated by and described with reference to FIG. 4.

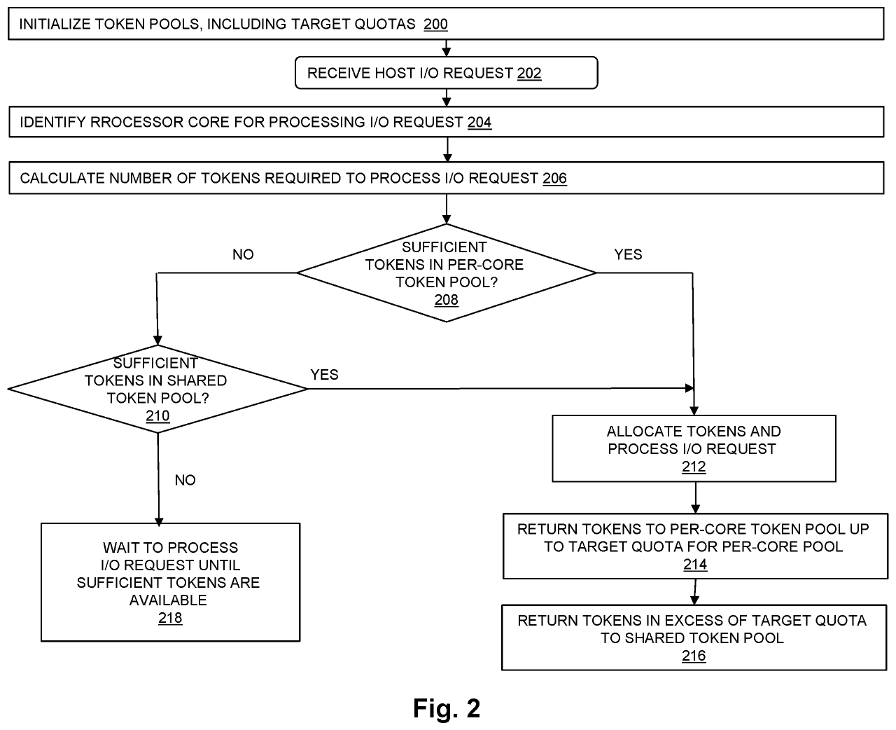

FIG. 2 is a flow chart showing an illustrative example of steps performed during operation of some embodiments of the disclosed multilevel token pool technology. At step 200 a shared token pool and multiple per-core token pools are initialized. Each one of the per-core token pools individually corresponds to a respective one of the processor cores in a data storage system. The initialization performed at step 200 may include setting the number tokens contained in the shared token pool to an initial value and setting the number of tokens contained in each one of the per-core token pools to another initial value. For example, the initial number of tokens contained in each one of the per-core token pools may be set to a predetermined low watermark value that defines a minimum number of tokens that may be contained in any per-core token pool at any time. Alternatively, the number of tokens contained in each one of the per-core tokens pools may initially be set equal to zero. Also at step 200, a target quota for each one of the per-core token pools may be set to a predetermined initial value.

At step 202, a host I/O request (e.g. one of Host I/O Requests 112) is received by the data storage system (e.g. by Storage Processor 120).

At step 204, a processor core in the data storage system is identified to be used when processing the host I/O request received at step 202. In some embodiments, the processor cores of the data storage system are organized into groups, where a first group of processor cores is used to perform in-line processing of received host I/O requests, and a second group of processor cores is used to perform background tasks. For example, the processor core that is identified at step 204 to be used to process the host I/O request received at step 202 may one of the processor cores in the first group, e.g. a processor core in the first group that is currently less utilized than the other processor cores in the first group.

At step 206, the number of tokens that is required to be allocated in order for the host I/O request received at step 202 to be processed is calculated. The number of tokens required to be allocated in order for the host I/O request to be processed may, for example, be calculated based on the size of the host data associated with the host I/O request, with larger numbers of required tokens being calculated for larger amounts host data. Alternatively, or in addition, the number of tokens required to be allocated in order for the host I/O request to be processed may be calculated based on the type of the host I/O request, with larger numbers of required tokens being calculated for write I/O requests than for host I/O read requests.

At step 208, the disclosed technology (e.g. Host I/O Request Processing Logic 132 in FIG. 1), determines whether there are sufficient tokens in the per-core token pool corresponding to the processor core identified at step 204 in order for the host I/O request to be processed only using tokens allocated from the per-core token pool corresponding to the processor core identified at step 204. For example, the number of tokens required to be allocated for the host I/O request to be processed is compared to a total number of tokens that are currently contained in the per-core token pool corresponding to the processor core identified at step 204. If the total number of tokens currently contained in the per-core token pool corresponding to the processor core identified at step 204 is equal to or greater than the number of tokens required to be allocated for the host I/O request to be processed, then there are sufficient tokens in the per-core token pool alone, and step 208 is followed by step 212. Otherwise, there are not sufficient tokens in the per-core token pool alone, and step 208 is followed by step 210. When step 208 is followed by step 212, tokens are allocated at step 212 only from the per-core token pool in order for the host I/O request to be processed, and there is advantageously no need to access the shared token pool.

In step 210, the disclosed technology (e.g. Host I/O Request Processing Logic 132), determines whether the shared token pool currently contains sufficient tokens to make up for the shortfall in tokens currently contained in the per-core token pool corresponding to the processor core identified at step 204, so that the host I/O request can still be processed. For example, the disclosed technology determines at step 210 whether the current number of tokens in the shared token pool is equal to or greater than the difference between the number of tokens required to be allocated in order for the host I/O request to be processed and the total number of tokens currently contained in the per-core token pool corresponding to the processor core identified at step 204. If so, then there are sufficient tokens in the shared token pool and per-core token pool combined, and step 210 is followed by step 212. Otherwise, there are currently not sufficient tokens in the combined shared token pool and per-core token pool, and step 210 is followed by step 218. When step 210 is followed by step 212, tokens are allocated at step 212 as necessary from both the shared token pool and/or the per-core token pool in order for the host I/O request to be processed. The number of tokens allocated from the shared token pool at step 212 is at least as large as the difference between the number of tokens required to be allocated in order for the host I/O request to be processed and the total number of tokens currently contained in the per-core token pool corresponding to the processor core identified at step 204.

In some embodiments or configurations, the number of tokens allocated from the shared token pool at step 212 may be greater than the difference between the number of tokens required to be allocated in order for the host I/O request to be processed and the total number of tokens currently contained in the per-core token pool corresponding to the processor core identified at step 204. Such a “bulk” allocation of tokens results in some number of tokens (e.g. the number of tokens that are allocated above the number of tokens required by the host I/O request) to be moved from the shared token pool to the per-core token pool.

Step 212 is followed by step 218 when there are currently not sufficient tokens in the combined shared token pool and per-core token pool in order for the host I/O request to be processed. In step 218, the disclosed technology (e.g. Host I/O Request Processing Logic 132) waits to process the received host I/O request until sufficient tokens are available for allocation from the per-core token pool and/or shared token pool, e.g. until the combined number of tokens in the per-core token pool and/or shared token pool is equal to or greater than the number of tokens required to process the host I/O request.

At step 214, the disclosed technology (e.g. Host I/O Request Processing Logic 132) begins returning the tokens that were allocated at step 212, i.e. the tokens that were previously allocated from the per-core token pool corresponding to the processor core identified at step 204 and/or from the shared token pool in order for the received host I/O request to be processed. At step 214, tokens are first returned to the per-core token pool, until the total number of tokens contained in the per-core target pool equals the target quota for the per-core token pool. When the total number of tokens contained in the per-core target pool equals the target quota for the per-core token pool, or when all the previously allocated tokens have been returned, step 214 is followed by step 216.

At step 216, the disclosed technology (e.g. Host I/O Request Processing Logic 132) returns to the shared token pool any tokens that were allocated at step 212 but not returned to the per-core token pool at step 214. In other words, at step 216, any previously allocated tokens that were not returned prior to the current number of tokens contained in the per-core reaching the target quota are returned to the shared token pool.

FIG. 3 is a flow chart showing an illustrative example of steps performed by some embodiments of the disclosed technology to periodically rebalance per-core token pools. At step 300, a periodic trigger is received, e.g. by Periodic Rebalancing Logic 144. The periodic trigger may be received multiple times per second, causing Periodic Rebalancing Logic 144 to execute multiple times per second. The remaining steps of FIG. 3 are performed for each one of the processor cores in Processor Cores 130 each time Periodic Rebalancing Logic 144 is executed.

At step 302, the disclosed technology detects whether a workload change has occurred for a selected one of the processor cores, referred to as the “current” processor core. For example, a workload change may be detected for the current processor core when that processor core has been moved from the group of processor cores being used to execute Host I/O Request Processing Logic 132 to the group of processor cores being used to execute Background Processing Logic 134. In that case, the disclosed technology detects that the workload of the current processor core has changed, and specifically that the workload of that processor has decreased. In another example, a workload change may be detected for the current processor core when that processor core has been moved to the group of processor cores being used to execute Host I/O Request Processing Logic 132 from the group of processor cores being used to execute Background Processing Logic 134. In that case, the disclosed technology detects that the workload of the current processor core has changed, and specifically that the workload of the current processor core has increased. If the workload of the current processor core has changed, step 302 is followed by step 304. Otherwise, step 302 is followed by step 306.

At step 304, the target quota for the per-core token pool corresponding to the current processor core is adjusted in response to the workload change detected at step 302. In response to a detected increase in the workload of the current processor core, the target quota of the corresponding per-core token pool is increased at step 304, e.g. to a predetermined target quota initial value, or by some predetermined number of tokens. In response to a detected decrease in the workload of the current processor core, the target quota of the corresponding per-core token pool is decreased at step 306, e.g. to a low watermark value that is the minimum number of tokens that may be contained in any per-core token pool at any time, or to zero. Step 304 is followed by step 306.

At step 306, the disclosed technology detects whether there is an imbalance between the current number of tokens contained in the per-core token pool corresponding to the current processor core and the number of tokens currently contained in the other per-core token pools. For example, if the current number of tokens contained in the per-core token pool corresponding to the current processor core is at least twice the number of tokens currently contained in the other per-core token pools, then at step 306 the disclosed technology detects that there is an imbalance between the current number of tokens contained in the per-core token pool corresponding to the current processor core and the number of tokens currently contained in the other per-core token pools. If an imbalance is detected, step 306 is followed by step 308. Otherwise, step 306 is followed by step 310.

At step 308, the target quota for the per-core token pool corresponding to the current processor core is lowered (e.g. by a predetermined number of tokens) in response to the imbalance detected at step 306. Step 308 is followed by step 310.

At step 310, the disclosed technology is done rebalancing with regard to the token pool corresponding to the current processor core. If there are any remaining processor cores for which steps 302-308 have not yet been performed in response to the periodic trigger received at step 300, one of those processor cores is selected as the new current processor core and steps 302-308 are repeated for that processor core.

FIG. 4 is a flow chart showing an illustrative example of steps performed by some embodiments of the disclosed technology to address token pool imbalances, specifically imbalances in which the combined per-core token pool and system pool have insufficient tokens for a received host I/O request, but tokens are available for allocation in another per-core token pool. In the embodiment illustrated in FIG. 4, the state variables for each per-core token pool additionally include a foreign access flag (“FOREIGN_ACCESS”) and an in-progress flag (“IN_PROGRESS”). When FOREIGN_ACCESS is set for a per-core token pool, it indicates that that per-core token pool is being accessed by host I/O request processing logic executing on a processor core other than the processor core corresponding to that per-core token pool. When IN_PROGRESS is set for a per-core token pool, it indicates that host I/O request processing logic executing on the corresponding processor core is currently in the process of allocating tokens from that per-core token pool The steps of FIG. 4 may, for example, be performed by Host I/O Request Processing Logic 132.

In the embodiment illustrated in FIG. 4, step 400 follows step 206 in FIG. 2. In the following description referring to FIG. 4, the per-core token pool corresponding to the processor core identified in step 204 of FIG. 2 is referred to as the “local” per-core token pool. In step 400, the IN_PROGRESS flag in the state variables for the local per-core token pool is set. In step 402, the FOREIGN_ACCESS flag in the state variables for the local per-core token pool is checked. If the FOREIGN_ACCESS flag is set, then step 402 is followed by step 404. Otherwise, step 402 is followed by step 406. In step 404, the Host I/O Request Processing Logic 132 i) clears the IN_PROGRESS flag, and ii) waits until the FOREIGN_ACCESS flag is subsequently clear, before proceeding again with step 400. Steps 400, 402, and 404 may be performed using non-atomic operations.

In step 406, Host I/O Request Processing Logic 132 determines whether the total number of currently contained in the combined local per-core token pool and system token pool is at least equal to the number of tokens required by the host I/O request received at 202 of FIG. 2. If so, step 406 is followed by step 212 in FIG. 2. Otherwise, step 406 is followed by step 408.

In step 408, Host I/O Request Processing Logic 132 determines whether there are sufficient tokens in another one of the per-core token pools (the “other” per-core token pool, different from the local per-core token pool) to make up for the shortfall in the total number tokens currently contained in the combined local per-core token pool and system token pool, in order to meet the requirement of the host I/O request, so that the host I/O request can still be processed. If not, then step 408 is followed by step 218 in FIG. 2, and the disclosed technology waits until sufficient tokens are available in the local per-core token pool, shared token pool, and/or other per-core token pool. Otherwise, step 408 is followed by step 410, in which the FOREIGN_ACCESS flag in the state variables for the other per-core token pool is set. The setting of the FOREIGN_ACCESS flag in the state variables for the other per-core token pool is performed using an atomic operation.

Step 410 is followed by step 412, during which the IN_PROGRESS flag in the state variables for the other per-core token pool is checked. The checking of the IN_PROGRESS flag in the state variables for the other per-core token pool is performed using an atomic operation. If that IN_PROGRESS flag is set, it may be repeatedly checked until it is clear. When the IN_PROGRESS flag in the state variables of the other per-core token pool is determined to be clear, step 412 is followed by step 414, in which the tokens needed to make up for the shortfall in the total number tokens currently contained in the combined local per-core token pool and system token pool are allocated atomically from the other per-core token pool, the FOREIGN_ACCESS flag in the state variables of the other per-core token pool is cleared using an atomic operation, and the host I/O request is processed. Step 414 is followed by step 214 in FIG. 2.

In the embodiment of FIG. 4, less costly non-atomic operations are advantageously used in steps 400, 402, and 404 to access the IN_PROGRESS and FOREIGN_ACCESS flags for the local per-core token pool, as may occur in the majority of use cases. The more costly atomic operations are performed when accessing tokens from the other per-core token pool, which is typically rare. The reversed order of accessing IN_PROGRESS and FOREIGN_ACCESS flags with regard to accessing the local per-core token pool and accessing the other per-core token pool ensures operational consistency.

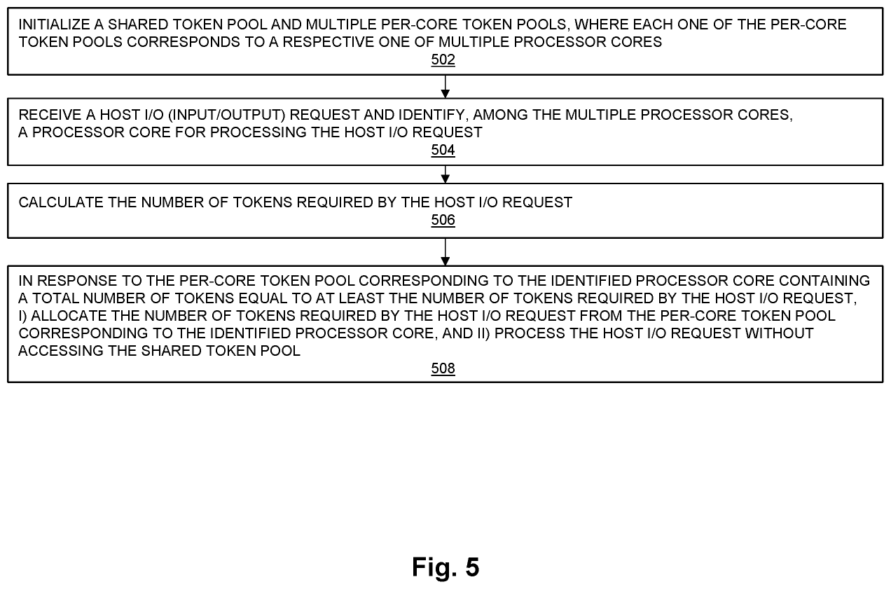

FIG. 5 is a flow chart showing an example of steps performed in some embodiments.

At step 502, a shared token pool and multiple per-core token pools are initialized. Each one of the per-core token pools corresponds to a respective one of multiple processor cores in a data storage system.

At step 504, a host I/O (Input/Output) request is received. Also at step 504, a processor core among the multiple processor cores is identified to be used for processing of the host I/O request.

At step 506, the number of tokens required to be allocated in order for the host I/O request to be processed is calculated.

At step 508, in response to detecting that the per-core token pool corresponding to the identified processor core currently contains a total number of tokens equal to at least the number of tokens required by the host I/O request, the disclosed technology i) allocates the number of tokens required by the host I/O request from the per-core token pool corresponding to the identified processor core, and ii) processes the host I/O request without accessing the shared token pool.

As will be appreciated by those skilled in the art, aspects of the technology disclosed herein may be embodied as a system, method, or computer program product. Accordingly, each specific aspect of the present disclosure may be embodied using hardware, software (including firmware, resident software, micro-code, etc.) or a combination of software and hardware. Furthermore, aspects of the technologies disclosed herein may take the form of a computer program product embodied in one or more non-transitory computer readable storage medium(s) having computer readable program code stored thereon for causing a processor and/or computer system to carry out those aspects of the present disclosure.

Any combination of one or more computer readable storage medium(s) may be utilized. The computer readable storage medium may be, for example, but not limited to, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any non-transitory tangible medium that can contain, or store a program for use by or in connection with an instruction execution system, apparatus, or device.

The figures include block diagram and flowchart illustrations of methods, apparatus(s) and computer program products according to one or more embodiments of the invention. It will be understood that each block in such figures, and combinations of these blocks, can be implemented by computer program instructions. These computer program instructions may be executed on processing circuitry to form specialized hardware. These computer program instructions may further be loaded onto programmable data processing apparatus to produce a machine, such that the instructions which execute on the programmable data processing apparatus create means for implementing the functions specified in the block or blocks. These computer program instructions may also be stored in a computer-readable memory that can direct a programmable data processing apparatus to function in a particular manner, such that the instructions stored in the computer-readable memory produce an article of manufacture including instruction means which implement the function specified in the block or blocks. The computer program instructions may also be loaded onto a programmable data processing apparatus to cause a series of operational steps to be performed on the programmable apparatus to produce a computer implemented process such that the instructions which execute on the programmable apparatus provide steps for implementing the functions specified in the block or blocks.

Those skilled in the art should also readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); or (b) information alterably stored on writable storage media (e.g. floppy disks and hard drives).

While the invention is described through the above exemplary embodiments, it will be understood by those of ordinary skill in the art that modification to and variation of the illustrated embodiments may be made without departing from the inventive concepts herein disclosed.

What is claimed is:

1. A method comprising:
initializing a shared token pool and multiple per-core token pools, wherein each one of the per-core token pools corresponds to a respective one of multiple processor cores;
receiving a host I/O (Input/Output) request and identifying, among the multiple processor cores, a processor core for processing the host I/O request;
calculating a number of tokens required by the host I/O request; and
in response to the per-core token pool corresponding to the identified processor core containing a total number of tokens equal to at least the number of tokens required by the host I/O request, allocating the number of tokens required by the host I/O request from the per-core token pool corresponding to the identified processor core and processing the host I/O request without accessing the shared token pool.

2. The method of claim 1, further comprising:
in response to the per-core token pool corresponding to the identified processor core not containing a total number of tokens equal to at least the number of tokens required by the host I/O request, allocating tokens from the shared token pool and processing the host I/O request.

3. The method of claim 2, wherein allocating tokens from the shared token pool comprises allocating tokens from the shared token pool in bulk, such that a total number of tokens allocated is larger than the number of tokens required by the host I/O request.

4. The method of claim 3, further comprising, in response to completion of the host I/O request, returning the allocated tokens at least in part by:
returning allocated tokens to the per-core token pool until a total number of tokens contained in the per-core target pool reaches a target quota for the per-core token pool; and
after the total number of tokens contained in the per-core token pool reaches the target quota for the per-core token pool, returning any remaining allocated tokens to the shared token pool.

5. The method of claim 4, wherein each one of the multiple per-core token pools has a separate target quota; and
wherein initializing the shared token pool and the per-core token pools includes setting the target quota of each one of the per-core token pools to an initial value.

6. The method of claim 5, further comprising periodically rebalancing the per-core token pools at least in part by:
detecting whether a workload change has occurred for any of the processor cores; and
in response to detecting that a workload change has occurred for one of the processor cores, changing a value of the target quota of the per-core token pool corresponding to that processor core to reflect the workload change.

7. The method of claim 6, further comprising:
in response to detecting that the per-core token pool corresponding to the identified processor core and the shared pool together do not contain a total number of tokens equal to at least the number of tokens required by the host I/O request, allocating tokens from another one of the per-core token pools and processing the host I/O request.

8. A data storage system comprising:
processing circuitry and a memory, wherein the processing circuitry includes multiple processor cores;
non-volatile data storage drives; and
wherein the memory has program code stored thereon, wherein the program code, when executed by the processing circuitry, causes the processing circuitry to:
initialize a shared token pool and multiple per-core token pools in the memory, wherein each one of the per-core token pools corresponds to a respective one of the multiple processor cores,
receive a host I/O (Input/Output) request and identify, among the multiple processor cores, a processor core for processing the host I/O request,
calculate a number of tokens required by the host I/O request, and
in response to the per-core token pool corresponding to the identified processor core containing a total number of tokens equal to at least the number of tokens required by the host I/O request, allocate the number of tokens required by the host I/O request from the per-core token pool corresponding to the identified processor core and process the host I/O request without accessing the shared token pool.

9. The data storage system of claim 8, wherein the program code, when executed by the processing circuitry, further causes the processing circuitry to:
in response to the per-core token pool corresponding to the identified processor core not containing a total number of tokens equal to at least the number of tokens required by the host I/O request, allocate tokens from the shared token pool and process the host I/O request.

10. The data storage system of claim 9, wherein the program code, when executed by the processing circuitry, further causes the processing circuitry to allocate tokens from the shared token pool at least in part by causing the processing circuitry to allocate tokens from the shared token pool in bulk, such that a total number of tokens allocated is larger than the number of tokens required by the host I/O request.

11. The data storage system of claim 10, wherein the program code, when executed by the processing circuitry, further causes the processing circuitry to, in response to completion of the host I/O request, return the allocated tokens at least in part by causing the processing circuitry to:
return allocated tokens to the per-core token pool until a total number of tokens contained in the per-core target pool reaches a target quota for the per-core token pool; and
after the total number of tokens contained in the per-core token pool reaches the target quota for the per-core token pool, return any remaining allocated tokens to the shared token pool.

12. The data storage system of claim 11, wherein each one of the multiple per-core token pools has a separate target quota; and
wherein the program code, when executed by the processing circuitry, further causes the processing circuitry to initialize the shared token pool and the per-core token pools at least in part by causing the processing circuitry to set the target quota of each one of the per-core token pools to an initial value.

13. The data storage system of claim 12, wherein the program code, when executed by the processing circuitry, further causes the processing circuitry to periodically rebalance the per-core token pools at least in part by causing the processing circuitry to:
detect whether a workload change has occurred for any of the processor cores; and
in response to detecting that a workload change has occurred for one of the processor cores, change a value of the target quota of the per-core token pool corresponding to that processor core to reflect the workload change.

14. The data storage system of claim 13, wherein the program code, when executed by the processing circuitry, further causes the processing circuitry to:
in response to detecting that the per-core token pool corresponding to the identified processor core and the shared pool together do not contain a total number of tokens equal to at least the number of tokens required by the host I/O request, allocate tokens from another one of the per-core token pools and process the host I/O request.

15. A computer program product including a non-transitory computer readable medium having instructions stored thereon, wherein the instructions, when executed on processing circuitry, cause the processing circuitry to perform steps including:
initializing a shared token pool and multiple per-core token pools, wherein each one of the per-core token pools corresponds to a respective one of multiple processor cores;
receiving a host I/O (Input/Output) request and identifying, among the multiple processor cores, a processor core for processing the host I/O request;
calculating a number of tokens required by the host I/O request; and
in response to the per-core token pool corresponding to the identified processor core containing a total number of tokens equal to at least the number of tokens required by the host I/O request, allocating the number of tokens required by the host I/O request from the per-core token pool corresponding to the identified processor core and processing the host I/O request without accessing the shared token pool.

16. The computer program product of claim 15, the steps further including:
in response to the per-core token pool corresponding to the identified processor core not containing a total number of tokens equal to at least the number of tokens required by the host I/O request, allocating tokens from the shared token pool and processing the host I/O request.

17. The computer program product of claim 16, wherein allocating tokens from the shared token pool includes allocating tokens from the shared token pool in bulk, such that a total number of tokens allocated is larger than the number of tokens required by the host I/O request.

18. The computer program product of claim 17, wherein the steps further include, in response to completion of the host I/O request, returning the allocated tokens at least in part by:
returning allocated tokens to the per-core token pool until a total number of tokens contained in the per-core target pool reaches a target quota for the per-core token pool; and
after the total number of tokens contained in the per-core token pool reaches the target quota for the per-core token pool, returning any remaining allocated tokens to the shared token pool.
